(19) United States
(12) Patent Application Publication
(10) Pub. No.: US 2025/0146984 A1
(43) Pub. Date: May 8, 2025

(54) SAMPLE SEPARATION DEVICE WITH FLUID DRIVE UNIT DECOUPLING

(71) Applicant: Agilent Technologies, Inc., Santa Clara, CA (US)

(72) Inventors: Blasius Nocon, Rheinstetten (DE); Konstantin Shoykhet, Karlsruhe (DE); Tobias Meier, Waldbronn (DE); Karsten Lehradt, Waldbronn (DE)

(21) Appl. No.: 18/932,428

(22) Filed: Oct. 30, 2024

(30) Foreign Application Priority Data
Nov. 6, 2023 (GB) 2316965.9

(51) Int. Cl. G01N 30/36; G01N 30/02; G01N 30/32

(52) U.S. Cl. CPC G01N 30/36; G01N 30/32; G01N 2030/027; G01N 2030/326; G01N 2030/328

(57) ABSTRACT

A sample separation apparatus includes a fluid drive arrangement having a first fluid drive unit and a second fluid drive unit for driving a mobile phase along a flow path to a sample separation unit, a sample accommodation volume configured to accommodate the fluidic sample and to be selectively fluidically coupleable with the flow path or fluidically decoupleable from the flow path, and a control unit configured to control respective operations of the fluid drive units, and to control a fluidically decoupling of the second fluid drive unit from the flow path in a decoupled operation mode of the sample separation apparatus. The control unit is further configured to control, in the decoupled operation mode, the decoupled second fluid drive unit for fluidically coupling to the sample accommodation volume, and intaking sample into the sample accommodation volume.

### CROSS-REFERENCE TO RELATED APPLICATIONS

The present application claims the benefit of United Kingdom Patent Application No. GB 2316965.9, filed on Nov. 6, 2023, which application is incorporated herein by reference in its entirety.

### TECHNICAL FIELD

The present disclosure relates to a sample separation apparatus for separating a fluidic sample, wherein the sample separation apparatus comprises a fluid drive arrangement with a first fluid drive unit and a second fluid drive unit for driving a mobile phase along a flow path to a sample separation unit. The sample separation apparatus further comprises a control unit configured to control respective operations of the fluid drive units, and to control a fluidically decoupling of the second fluid drive unit from the flow path in a decoupled operation mode. The present disclosure further relates to a method of operating a sample separation apparatus.

### BACKGROUND

Analytical devices are provided for analyzing a sample, for example using a sample separation apparatus.

For example, for liquid separation in a chromatography system, a mobile phase comprising a sample fluid (e.g. a chemical or biological mixture) with compounds to be separated is driven through a stationary phase (such as a chromatographic column packing), thus separating different compounds of the sample fluid which may then be identified. The term compound, as used herein, shall cover compounds which might comprise one or more different components.

The mobile phase, typically comprised of one or more solvents, is pumped under high-pressure typically through a chromatographic column containing packing medium (also referred to as packing material or stationary phase). As the sample is carried through the column by the liquid flow, the different compounds, each one having a different affinity to the packing medium, move through the column at different speeds. Those compounds having greater affinity for the stationary phase move more slowly through the column than those having less affinity, and this speed differential results in the compounds being separated from one another as they pass through the column. The stationary phase is subject to a mechanical force generated in particular by a hydraulic pump that pumps the mobile phase usually from an upstream connection of the column to a downstream connection of the column. As a result of flow, depending on the physical properties of the stationary phase and the mobile phase, a relatively high-pressure drop is generated across the column.

The mobile phase with the separated compounds exits the column and passes through a detector, which registers and/or identifies the molecules, for example by spectrophotometric absorbance measurements. A two-dimensional plot of the detector measurements against elution time or volume, known as a chromatogram, may be made, and from the chromatogram the compounds may be identified. For each compound, the chromatogram displays a separate curve feature also designated as a “peak”.

Hereby, a precisely controlled fluidic flow through a sample separation system is imperative, in particular for HPLC systems. This requires (in current HPLC systems) a pump which can provide this high flow precision and in turn low back-pressure pulsation level against the (possibly variable) flow resistance of the other components of the HPLC systems. This is usually achieved by using a dual-piston pump design, thereby driving each piston independently with active control feedbacks.

Furthermore, an additional pumping device (a metering device) may be used for metering the sample to be analyzed/separated. In a conventional design, the metering device is included into the fluid path of the HPLC System all the time except during the sample taking and preparation phase.

However, the metering device and the independent piston drives used in modern HPLC systems are expensive components, which have to be installed and maintained in a cost- and effort-consuming manner. Hereby, the metering device is conventionally only used in the sample taking and preparation phase.

### SUMMARY

There may be a need to operate a sample separation apparatus in a (cost) efficient manner, in particular with respect to the pump system.

According to an aspect of the disclosure, there is described a sample separation apparatus (e.g. a HPLC) for separating a fluidic sample, the sample separation apparatus comprising:
i) a fluid drive arrangement (for example two or more pumps) comprising a first fluid drive unit (comprising a first piston) and a second fluid drive unit (comprising a second piston) for driving a mobile phase along a flow path to a sample separation unit (e.g. a chromatographic column);
ii) a sample accommodation volume (e.g. a sample needle and/or a sample loop) configured to accommodate the fluidic sample and in particular being configured to be selectively fluidically coupleable with the flow path (e.g. to introduce accommodated sample) or fluidically decoupleable from the flow path (e.g. during sample intake) (in an example the sample accommodation volume is inseparably connected to the second fluid drive and thus they are connected/disconnected to the flow path always together); and
iii) a control unit (a control device, a control system, e.g. a processor, etc.) configured to control respective operations of the fluid drive units, and to control a fluidically decoupling (fluidically disconnect) (e.g. by means of one or more switching valves) of the second fluid drive unit from the flow path in a decoupled operation mode of the sample separation apparatus, wherein the control unit is further configured to control, in the decoupled operation mode, the decoupled second fluid drive unit for
a) fluidically coupling (fluidically connect) to the sample accommodation volume, and
b) intaking sample into the sample accommodation volume (with the second fluid drive unit operating as a metering device).

According to a further aspect of the present disclosure, there is described a method of operating a sample separation apparatus (e.g. as described above), the method comprising:
i) driving a mobile phase along a flow path to a sample separation unit by a fluid drive arrangement, which comprises a first fluid drive unit and a second fluid drive unit;
ii) accommodating a fluidic sample in a sample accommodation volume and in particular selectively fluidically coupling the sample accommodation volume with the flow path or fluidically decoupling the sample accommodation volume from the flow path;
iii) fluidically decoupling the second fluid drive unit from the flow path in a decoupled operation mode of the sample separation apparatus,
iv) fluidically coupling, in the decoupled operation mode, the decoupled second fluid drive unit to the sample accommodation volume, and
v) intaking sample into the sample accommodation volume (by the second fluid drive unit).

According to a further aspect of the present disclosure, there is described a use (method of using) of a fluid drive unit, being decoupled from a separation flow path, from a fluid drive arrangement of a chromatographic device as a metering device to trigger an intake of fluidic sample into a sample accommodation volume.

In the context of this document, the term “fluidic sample” may particularly denote any liquid and/or gaseous medium, optionally including also solid particles, which is to be analyzed. Such a fluidic sample may comprise a plurality of fractions of molecules or particles which shall be separated, for instance small mass molecules or large mass biomolecules such as proteins. Separation of a fluidic sample into fractions involves a certain separation criterion (such as mass, volume, chemical properties, etc.) according to which a separation is carried out.

In the context of this document, the term “mobile phase” may particularly denote any liquid and/or fluidic, e.g. super-critical, medium which may serve as fluidic carrier of the fluidic sample during separation. A mobile phase may be a solvent or a solvent composition (for instance composed of water and an organic solvent such as ethanol or acetonitrile). In an isocratic separation mode of a liquid chromatography apparatus, the mobile phase may have a constant composition over time. In a gradient mode, however, the composition of the mobile phase may be changed over time, in particular to desorb fractions of the fluidic sample which have previously been adsorbed to a stationary phase of a separation unit.

In the context of this document, the term “sample separation apparatus” may particularly denote any apparatus which is capable of separating different fractions of a fluidic sample by applying a certain separation technique, in particular liquid chromatography.

The term “separation unit” may particularly denote a fluidic member through which a fluidic sample is transferred and which is configured so that, upon conducting the fluidic sample through the separation unit, the fluidic sample will be separated into different groups of molecules or particles. An example for a separation unit is a liquid chromatography column which is capable of trapping or retarding and selectively releasing different fractions of the fluidic sample.

In the context of this application, the term “sample accommodation volume” may particularly denote a defined portion or section of a flow path, a fluidic conduit or a fluidic member (such as a fluidic valve) in which a predefined amount of fluid may be at least temporarily accommodated. In an embodiment, the fluid accommodation volumes may be sample loops (e.g. fluidically connected to ports of a modulator valve). The fluid accommodation volume may be at least temporarily fluidically decoupled from a flow path or main path. By a switching mechanism, the sample accommodation volume may be first coupled to a certain location in a sample separation apparatus, while being later alternatively or additionally coupled to a different location in the sample separation apparatus.

In the context of this document, the term “fluid drive unit” may particularly denote a device configured to drive a fluid along a flow path. In an embodiment, a fluid drive unit may be realized as one or more pump units. In a basic example, a fluid drive unit may comprise one pump unit with a piston and a respective piston cylinder (pump volume) (and a respective motion source such as a motor). In a further example, a fluid drive unit may comprise two (or more) pump units, e.g. two piston cylinders with respective pistons (e.g. dual pump) (and a common motion source). In an example, a fluidic drive unit may be described as a pumping appliance comprising—in the case of a piston or plunger pump—one or plurality of the pump cylinders with pistons or plungers (pump units). In particular, the pump units of a fluid drive unit may be driven by a single motion/energy source, e.g. by a single motor. Accordingly, in an example, the pump units (e.g. piston/cylinder pairs) of a fluid drive unit may be mechanically dependent and may not be driven independently (due to their mechanical coupling). Hence the term “fluid drive unit” may e.g. refer to a single piston drive as well as to a coupled double-piston drive.

The term “coupled fluid drive units” may be understood in this context as driving two or more pumps by the same energy source (motor) and/or coupling them via gears or in other way. Yet, the coupling may be such that the piston positions are mechanically coupled and cannot be changed independently (are mechanically dependent from each other).

The term “flow path” may be understood in this context as a fluidic path engaged (in a present switching and configuration state of the separation apparatus) in fluid transport from a pump drive unit to the sample separation unit.

According to an exemplary embodiment, the disclosure may be based on the idea that a sample separation apparatus (in particular an HPLC) can be operated in an especially (cost) efficient manner, when a fluid drive arrangement of the sample separation apparatus comprises at least two fluid drive units (e.g. pump pistons), and wherein the system (e.g. by means of controlling a valve controlled by a control unit) is configured to temporarily decouple the second fluid drive unit from the first fluid drive unit, and to couple the second fluid drive unit instead to the sample accommodation volume (e.g. a sample loop), so that intaking sample into the sample accommodation volume can be performed by the second fluid drive unit.

By this mode of operation, the conventional additional metering device for intaking sample into the sample accommodation volume may become obsolete. In this manner, high material and maintenance costs (as well as space requirements) for the metering device could be saved, while the sample separation apparatus could still be operated in an efficient and reliable manner.

In other words, the disclosure functionally integrates fluid drive unit (pump drive) and metering device of current HPLC systems into or in a single device and may engage one of the pistons (fluidic drive units) of the pump also as a metering device (or, contrarily, engage the metering device of the sampler as a pump drive). Thereby, the number of the (motorized) pump drives in the system may be reduced by (at least) one. Because the metering task will fully occupy the corresponding fluidic drive unit for the time of sample taking and injection, the fluidic connections may be switched by a valve, to connect the parts of the fluidic path as required for a specific function.

The disclosure may enable a reduction of complexity and costs of sample separation systems and/or enhance the performance with low or no additional cost. Compared to previous approaches, the disclosure may require less components and reuses already existing sub-units of a sample separation apparatus to perform multiple tasks instead of single task per sub-unit. Hence, the disclosure may provide a significant cost saving potential over current architectures/operation modes.

In an embodiment, in the decoupled operation mode, the first fluid drive unit is coupled to the separation unit. The first fluid drive unit may maintain the fluidic flow to the sample separation unit, yet without an injected sample. Thereby, the high pressure may be efficiently maintained, while artifacts may be streamed out of the flow path.

In an embodiment, in the decoupled operation mode, the second fluid drive unit is decoupled from the sample separation unit. Thus, the second fluid drive unit can function as a metering device and intake a sample under normal/ambient pressure. This may be enabled by fluidic decoupling or pressure-decoupling the second fluid drive unit from the high-pressure flow path, e.g. by breaking the fluidic connections of the second fluid drive unit to the first fluid drive unit and to the sample separation unit and establishing the fluidic connection between first fluid drive unit and sample separation unit.

In an embodiment, in the decoupled operation mode, the second drive unit is operated as a metering device, in particular a dosing (or metering) pump, to draw the fluidic sample from a sample container (e.g. a vial), for example into a sample accommodation volume. When the second drive unit is configured as a pump, e.g. with a piston, it may efficiently and reliably fulfill the task of drawing a specific amount of fluidic sample into the sample accommodation volume.

In an embodiment, the control unit is further configured to, in the decoupled operation mode, at least partially or temporarily block a sample flow path, that leads from the second fluid drive unit through the sample accommodation unit. The sample flow path may comprise the second fluid drive unit, the sample accommodation volume, a fluidic switching, valve a needle seat, and a needle. Also only segments of the the sample flow path rather than the entire path may be blocked. The blockage may be in particular in process direction downstream of the sample accommodation unit. Still another blockage point may be located in the process direction upstream from the second fluid drive unit. When the second fluid drive unit provides a pressure (by the pumping process), and the sample flow path (e.g. at the switching valve) is (at least partially) blocked, the fluidic sample may be compressed. Such a pre-compressed sample may be injected in the high-pressure flow path in an efficient and robust manner. In an example, a pre-compressed sample may be fluidically disconnected (isolated) in a fluidically blocked segment of a fluidic flow path and stored in that segment in the pre-compressed state for a certain time interval before it may be injected into the high-pressure flow path.

In an embodiment, the control unit is further configured to control (e.g. by one or more switching valves) a (fluidic connection) coupling between the first fluid drive unit and the second fluid drive unit, in a coupled operation mode, wherein the first fluid drive unit and the second fluid drive unit are fluidically coupled with each other, in particular in series or in parallel. The coupled operation mode may correspond to the normal operation mode of a sample separation apparatus (HPLC): a pump with two pistons (two pump units) is applied to pump a mobile phase to the sample separation unit. The flow of the mobile phase goes hereby through the sample accommodation volume in order to take-up the accommodated fluidic sample in the high-pressure path. Hence, the described sample separation apparatus may efficiently switch between the normal operation mode and the decoupled bypass operation mode, wherein the second drive unit operates as a metering device.

In an embodiment, in the coupled operation mode, the first fluid drive unit and the second fluid drive unit are pressure-coupled with each other. In other words, both pump drives are fluidically connected and operate in the high-pressure domain.

In an embodiment, in the decoupled operation mode, the first fluid drive unit and the second fluid drive unit are pressure-decoupled from each other, in particular wherein the first fluid drive unit is coupled in a high-pressure path and/or wherein the second fluid drive unit is coupled in a low-pressure path. The pressure-decoupling of the second fluid drive unit may enable an efficient sample intake.

In an embodiment, in the coupled operation mode, a mobile phase, in particular a solvent, is drawn by the first fluid drive unit, in particular from a solvent container, and then streamed to the second fluid drive unit. In this normal operation mode, the first fluid drive unit is arranged in process direction upstream of the second fluid drive unit.

In an embodiment, in the coupled operation mode, the first fluid drive unit and the second fluid drive unit (or a first pump unit and a second pump unit) are connected in parallel (or in series). delivering the solvent from the solvent container into the high pressure flow path simultaneously or alternatingly, whereas the high pressure flow path may comprise the solvent accommodation volume, such that the sample accommodated therein may be taken up and transported with the fluid flow towards the sample separation unit.

In an embodiment, in the coupled operation mode, the mobile phase is streamed, in process direction downstream of the fluid drive arrangement, through the sample accommodation unit, thereby taking up the fluidic sample accommodated in the sample accommodation unit.

In an embodiment, the sample accommodation unit is configured as one of a sample loop, a multi-sample storage (“sample park deck”, e.g. several sample accommodation units coupled in parallel), a sampler, an autosampler, an injection needle. Depending on the desired application, the fluidic sample may be accommodated in a variety of different volumes, many of them being established in the field of chromatography. Hence, the present disclosure may be implemented directly in a plurality of established applications. There may be also a combination of two or more sample accommodation volumes. For example, a sample may be in-taken by a sample needle as a first sample accommodation volume and then transported to a sample loop as a second sample accommodation volume. In any case, the second fluid drive unit may be directly applied to execute (by metering) an intake of the sample to the sample volume, e.g. drawing the sample into the needle. The sample may then be at least partially streamed to or into the sample loop.

In an embodiment, the first fluid drive unit and/or the second drive unit comprises two or more pump units (a pump unit for example comprises a piston/cylinder), which are connected to a common motion source, in particular a motor. In an embodiment, the two or more pump units are mechanically dependent from each other (mechanically coupled and not independent in motion).

In an embodiment, the fluid drive arrangement is configured as a chromatographic pump, comprising in the coupled mode two (or more) pump pistons (pump units), for example an isocratic parallel pump, isocratic serial pump, low pressure mixing serial or parallel pump (aka quaternary pump), high pressure mixing multichannel pump, e.g. a binary pump with parallel or serial drive configuration within the individual pump channels. In an embodiment. the first fluid drive unit is arranged in process direction upstream of the second fluid drive unit. In an embodiment, the first fluid drive unit and the second fluid drive unit are fluidically coupled with each other in series or in parallel. Thus, a plurality of established pump architectures may be directly applied.

In an embodiment, the sample separation apparatus further comprises a switching unit, in particular a fluidic valve (e.g. a rotary valve, a shear valve or a set of shut-off valves, e.g. high pressure needle valves), arranged in process direction between the first fluid drive unit and the second fluid drive unit (see also FIGS. 9 and 10). The switching unit may be coupled to the control unit, wherein the control unit is then configured to switch between the coupled operation mode and the decoupled operation mode by means of the switching unit. Switching valves are well established in the field of liquid chromatography. Exemplary implementations are shown in FIGS. 2 to 4.

In an embodiment, the sample separation device is free of a dedicated metering device, in particular a metering pump. As described above, significant installation and maintenance costs may be saved in this manner. Further, less operation space may be required. It is understood, that, though the second fluidic drive unit may be located close to or in the sampler or autosampler and may be seen as a metering unit, it can be configured to fulfill the function of a fluidic drive of the chromatographic pump. Thus, both views, i.e. i) eliminating the metering device from the sampler whereas its function may be fulfilled by one fluidic drive from a chromatographic pump, and ii) eliminating one fluidic drive from a chromatographic pump whereas its function may be transferred to a metering device are equivalent.

In an embodiment, the sample separation apparatus further comprises a damper device, in particular a passive damper device, for damping flow pulsation (pressure spikes) in the flow path. In particular in the bypass operation mode, the damper device may compensate for the decoupled second fluid drive unit and maintain a stable flow from first fluid drive unit to the sample separation unit.

In the context of this document, the term “damper device” may in particular refer to a device that is suitable to fulfill a damping function with respect to a fluid flow path of a sample separation device. In a most basic example, the damper device may comprise a volume that can be flown through with a solvent. Already in this manner, a damping can be achieved. In an embodiment, the volume is able to withstand the high pressures of e.g. 1000 bar of the fluid. In more sophisticated examples, an elastic element such as a membrane may constitute one wall of the fluid volume. The outer side (with respect to the solvent flow path) of the membrane may be supported by a liquid, enclosed in a thick-wall container, such that compressibility of the liquid provides elastic property of the flow path and enables pressure or volume pulsation damping. The thick-wall container may contain a solid body along with the damping liquid filling, such that the combined overall thermal expansion coefficient of the solid body (e.g. ceramic) and of the damping liquid equals to the thermal expansion coefficient of the thick-wall container, and thus the membrane position and the volume of the high pressure flow path remain essentially unchanged in a broad temperature range, e.g. from 4° C. to 60° C. Still damper embodiments may include flow-through elastic structures such as bourdon-tubes or alike, metal or ceramic microfluidic structures etc. A plurality of different damper devices are established in the field of liquid chromatography an may be implemented in a straightforward and reliable manner.

In an embodiment, the control unit is configured to invoke switching of a damper device into the high pressure path and thus enable its damping operation. For example, a passive damper may be comprised in the flow path to dampen down the flow pulsation during one of the drives is occupied for metering task or to assist for the sample pre-compression. Also the control unit may invoke (by means of a switching valve or of plurality of switching valves) a switching state characterized by: the second fluidic drive unit is connected into the high pressure fluidic path (coupled operation mode), the damper, previously pressurized during its damping operation within the high pressure fluidic path, is connected to the sample accommodation volume containing the sample, whereas the fluidic path segment comprising the damper and the sample accommodation volume is completely fluidically blocked. By this the damper (i.e. the elastic energy comprised therein) may serve for bringing the fluidic sample to nearly the level of the system high pressure.

In an embodiment, the control unit is configured to couple the damper device, in particular in the decoupled operation mode, in the flow path between the first fluidic drive unit and the sample separation device. Hereby, the damper device may efficiently compensate for the decoupled second fluid drive unit for maintaining the fluid flow path in a stable regime.

In an embodiment, the damper device comprises an elastic element, in particular a membrane. In an embodiment, the damper device comprises a damper device volume, configured to accommodate a fluid/liquid. In an embodiment, the elastic element is arranged on top (as a cover) of the volume.

In an embodiment, the control unit is further configured to: pressure-decoupling the second fluid drive unit from the first fluid drive unit in a pressure-decoupled operation mode. In an embodiment, the control unit is further configured to i) pressurizing the sample accommodation volume before fluidically coupling the sample accommodation volume with the flow path, wherein the pressurizing is done while the first fluid drive unit is operating, and/or ii) de-pressurizing the sample accommodation volume after fluidically coupling the sample accommodation volume with the flow path, for example for preparing a subsequent intake of fluidic sample in the sample accommodation volume, wherein the de-pressurizing may be done while the first fluid drive unit is operating. In this manner, an efficient sample pre-compression may be realized within the described sample separation apparatus.

In an embodiment, a concept of the present disclosure may be to (temporarily) use one of two pump drives (for example by having an adequate switching unit, e.g. valve, between the two pumps) for metering sample into a sample loop, while the other pump maintains flow into the system. As a further aspect, a damping unit may be used (and also adequately coupled to the switching unit) in order to smoothen/continue the flow during the decoupling of one of the pump drives (for metering).

In an embodiment, the sample separation device is configured as a fluidic chromatography device, more in particular a high-performance liquid chromatography, HPLC, device.

In preparative chromatography systems, a liquid as the mobile phase is provided usually at a controlled flow rate (e. g. in the range of 1 mL/min to thousands of mL/min, e.g. in analytical scale preparative LC in the range of 1-5 mL/min and preparative scale in the range of 4-200 mL/min) and at pressure in the range of tens to hundreds bar, e.g. 20-600 bar.

In high performance liquid chromatography (HPLC), a liquid as the mobile phase has to be provided usually at a very controlled flow rate (e.g. in the range of microliters to milliliters per minute) and at high-pressure (typically 20-100 MPa, 200-1000 bar, and beyond up to currently 200 MPa, 2000 bar) at which compressibility of the liquid becomes noticeable.

In analytical devices, specifically in liquid chromatography (in particular HPLC), it may be important to provide an accurate solvent flow, even in the case that specific properties of the solvent are not known or are not downloaded to the control unit of a analytical device.

Embodiments may be implemented in conventionally available HPLC systems, such as the analytical Agilent 1290 Infinity II LC system or the Agilent 1290 Infinity II Preparative LC/MSD system (both provided by the applicant Agilent Technologies—see www.agilent.com).

One embodiment of a sample separation apparatus comprises a pump having a pump piston for reciprocation in a pump working chamber to compress liquid in the pump working chamber to a high pressure at which compressibility of the liquid becomes noticeable. This pump or the control unit may be configured to process numeric values of solvent properties (the values being provided to the pump by means of operator's input, notification from another module of the instrument or similar or the pump elsewise derives solvent properties before or during its operation).

The sample separation unit of the sample separation apparatus may comprise a chromatographic column (see for instance wikipedia.org/wiki/Column_chromatography) comprising a stationary phase. The column may be a glass or steel tube (for instance with a diameter from 50 μm to 5 mm and a length of 1 cm to 1 m) or a microfluidic column (as disclosed for instance in EP 1577012 or the Agilent 1200 Series HPLC-Chip/MS System provided by the applicant Agilent Technologies). The individual components are retained by the stationary phase differently and at least partly separate from each other while they are propagating at different speeds through the column with the eluent. At the end of the column they elute one at a time or at least not entirely simultaneously. During the entire chromatography process the eluent may be also collected in a series of fractions. The stationary phase or adsorbent in column chromatography usually is a solid material. The most common stationary phase for column chromatography is silica gel, surface modified silica gel, followed by alumina. Cellulose powder has often been used in the past. Most common chromatography modes are ion exchange chromatography, reversed-phase chromatography (RP), affinity chromatography or expanded bed adsorption (EBA). The stationary phases are usually fine powders or gels and/or are microporous for an increased surface.

The mobile phase (or eluent) can be a pure solvent or a mixture of different solvents (such as water and an organic solvent such as ACN, acetonitrile). It can be chosen for instance to adjust the retention of the compounds of interest and/or the amount of mobile phase to run the chromatography. The mobile phase can also be chosen so that the different compounds or fractions of the fluidic sample can be separated efficiently. The mobile phase may comprise an organic solvent like for instance methanol or acetonitrile, often diluted with water. For gradient operation water and organic solvent are delivered in separate containers, from which the gradient pump delivers a programmed blend to the system. Other commonly used solvents may be isopropanol, tetrahydrofuran (THF), hexane, ethanol and/or any combination thereof or any combination of these with aforementioned solvents.

A fluidic sample analyzed by a sample separation apparatus according to an exemplary embodiment of the disclosure may comprise but is not limited to any type of process liquid, natural sample like juice, body fluids like plasma or it may be the result of a reaction like from a fermentation broth.

The pressure, as generated by the fluid drive, in the mobile phase may range from 2-200 MPa (20 to 2000 bar), in particular 10-150 MPa (150 to 1500 bar), and more particularly 50-120 MPa (500 to 1200 bar).

The sample separation apparatus, for instance an HPLC system, may further comprise a detector for detecting separated compounds of the fluidic sample, a fractionating unit for outputting separated compounds of the fluidic sample, or any combination thereof. For example, a fluorescence detector may be implemented.

Embodiments of the present disclosure may be partly or entirely embodied or supported by one or more suitable software programs or products, which can be stored on or otherwise provided by any kind of non-transitory medium or data carrier, and which might be executed in or by any suitable data processing unit such as an electronic processor-based computing device (or system controller, control unit, etc.) that includes one or more electronic processors and memories. Software programs or routines (e.g., computer-executable or machine-executable instructions or code) may be applied in or by the control unit, e.g. a data processing system such as a computer, such as for executing any of the methods described herein. For example, one embodiment of the present disclosure provides a non-transitory computer-readable medium that includes instructions stored thereon, such that when executed on a processor, the instructions perform the steps of the method of any of the embodiments disclosed herein.

Other objects and many of the attendant advantages of embodiments of the present disclosure will be readily appreciated and become better understood by reference to the following more detailed description of embodiments in connection with the accompanying drawings. Features that are substantially or functionally equal or similar will be referred to by the same reference signs.

### BRIEF DESCRIPTION OF DRAWINGS

Other objectives and many of the attendant advantages of embodiments of the present invention will become readily perceived and better understood with reference to the following more detailed specification of embodiments in connection with the accompanying drawings. Features which are substantially or functionally the same or similar are designated by the same reference signs. The drawings are schematic.

FIG. 1 shows a liquid sample separation apparatus in accordance with embodiments of the present disclosure, particularly used in high performance liquid chromatography (HPLC).

FIG. 2 shows a sample separation device in a coupled operation mode, in accordance with embodiments of the present disclosure.

FIG. 3 shows a sample separation device in a first transition state, in accordance with embodiments of the present disclosure.

FIG. 4 shows a sample separation device in a decoupled operation mode, in accordance with embodiments of the present disclosure.

FIG. 5 shows a sample separation device fluid path in a coupled operation mode, in accordance with embodiments of the present disclosure.

FIG. 6 shows a sample separation device fluid path in the first transition state, in accordance with embodiments of the present disclosure.

FIG. 7 shows a sample separation device fluid path in a decoupled operation mode, in accordance with embodiments of the present disclosure.

FIG. 8 shows a fluid drive arrangement in a coupled operation mode, in accordance with embodiments of the present disclosure.

FIG. 9 shows a fluid drive arrangement in a decoupled operation mode, in accordance with embodiments of the present disclosure.

FIG. 10 shows a damper device, in accordance with embodiments of the present disclosure.

FIG. 11 shows a sample separation device fluid path in a coupled operation mode, wherein each fluid drive unit comprises one pump unit, in accordance with embodiments of the present disclosure.

FIG. 12 shows a sample separation device fluid path in a decoupled operation mode, wherein each fluid drive unit comprises one pump unit, in accordance with embodiments of the present disclosure.

FIG. 13 shows a sample separation device fluid path in a coupled operation mode, wherein one fluid drive unit comprises two pump units, in accordance with embodiments of the present disclosure.

FIG. 14 shows a sample separation device fluid path in a decoupled operation mode, wherein one fluid drive unit comprises two pump units, in accordance with embodiments of the present disclosure.

### DETAILED DESCRIPTION

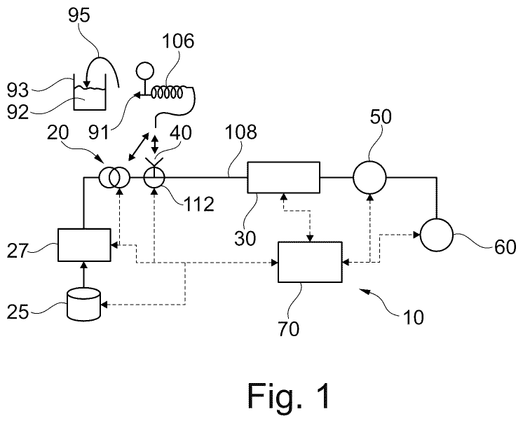

FIG. 1 depicts a general schematic of a liquid separation system as example for a sample separation apparatus 10 according to an exemplary embodiment of the disclosure. A pump as fluid drive arrangement 20 receives a mobile phase from a solvent supply 25, typically via a degasser 27, which degases and thus reduces the amount of dissolved gases in the mobile phase. The mobile phase drive or fluid drive arrangement 20 drives the mobile phase through a sample separation unit 30 (such as a chromatographic column) comprising a stationary phase. A sampler or injector 40, comprising a fluidic valve 112, can be provided between the fluid drive arrangement 20 and the separation unit 30 in order to subject or add (often referred to as sample introduction) a sample fluid into the mobile phase. The stationary phase of the separation unit 30 is configured for separating compounds of the sample liquid. A detector 50 is provided for detecting separated compounds of the sample fluid. A fractionating unit 60 can be provided for outputting separated compounds of sample fluid.

While the mobile phase can comprise one solvent only, it may also be mixed from plural solvents. The corresponding mixing process might be a low pressure mixing and provided upstream of the fluid drive arrangement 20, so that the fluid drive arrangement 20 already receives and pumps the mixed solvents as the mobile phase. Alternatively, the fluid drive arrangement 20 may comprise plural individual pumping units or fluid drive units, each receiving and pumping a different solvent or mixture, so that the mixing of the mobile phase (as received by the separation unit 30) occurs at high pressure side and downstream of the fluid drive arrangement 20 (or as part thereof). The composition (mixture) of the mobile phase may be kept constant over time, the so called isocratic mode, or varied over time, the so called gradient mode.

A data processing unit or control unit 70 (which can be a PC or workstation, alternatively it can be also a dedicated controller as a hand-held controller, or a processing unit such as microcontroller, microprocessor or plurality of those operating in coordinated manner or at least interacting, contained in or being part of one or more of the system modules 25, 27, 20, 30, 50, 60) may be coupled (as indicated by the dotted arrows) to one or more of the devices in the sample separation apparatus 10 in order to receive information and/or control operation. For example, the control unit 70 may control operation of the fluid drive arrangement 20 (for example setting control parameters) and receive therefrom information regarding the actual working conditions (such as output pressure, etc. at an outlet of the pump 20). The control unit 70 may also control operation of the solvent supply 25 (for example setting the solvent/s or solvent mixture to be supplied) and/or the degasser 27 (for example setting control parameters such as vacuum level) and might receive therefrom information regarding the actual working conditions (such as solvent composition supplied over time, vacuum level, etc.). The control unit 70 might further control operation of the sampling unit or injector 40 (for example controlling sample injection or synchronization of sample injection with operating conditions of the fluid drive arrangement 20). The separation unit 30 might also be controlled by the control unit 70 (for example selecting a specific flow path or column, setting operation temperature, etc.), and send—in return—information (for example operating conditions) to the control unit 70. Accordingly, the detector 50 might be controlled by the control unit 70 (for example with respect to spectral or wavelength settings, setting time constants, start/stop data acquisition), and send information (for example about the detected sample compounds) to the control unit 70. The control unit 70 might also control operation of the fractionating unit 60 (for example in conjunction with data received from the detector 50), which provides data back.

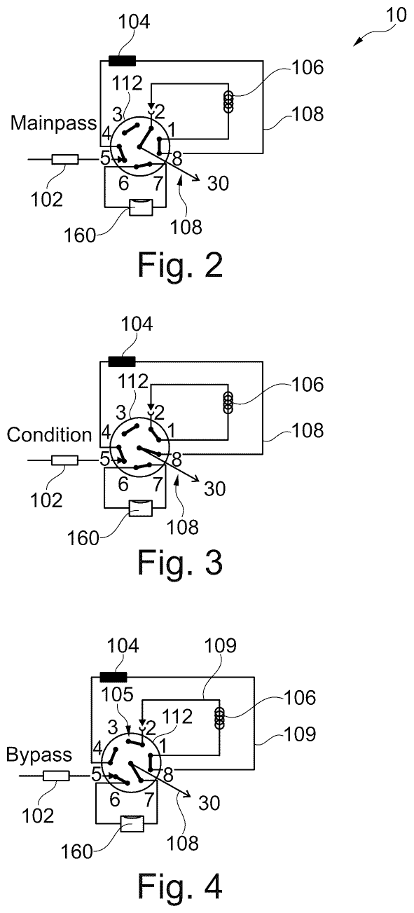

As already mentioned, the sample separation apparatus 10 for separating the fluidic sample according to FIG. 1 comprises the fluid drive arrangement 20, for instance embodied as a pump, comprising two fluid drive units 102, 104 (each configured as high-pressure pump) (see, e.g., FIGS. 2-7) for driving a mobile phase along a flow path 108 to sample separation unit 30, which is embodied as chromatographic separation column. A sample accommodation volume 106 is here embodied as a sample loop and is configured for temporarily accommodating the fluidic sample before injection. The sample accommodation volume 106 is hence configured to be selectively fluidically coupleable with the flow path 108 (for sample injection) or fluidically decoupleable from the flow path 108 (for sample intake). The sample accommodation volume 106 may also be denoted as sample introduction unit, and may for instance be a sample loop, an injection valve, an autosampler, etc. The sample accommodation volume 106 is responsible for filling the fluidic sample into the flow path 108.

The control unit 70, which may be a processor and which may be configured for controlling the entire operation of the sample separation apparatus 10, may be configured for pressure decoupling a respective one of the fluid drive units 102, 104 from the flow path 108 in one operation mode of the sample separation apparatus 10 to enable the at least one pressure-decoupled fluid drive unit 102, 104 to pressurize the sample accommodation volume 106 before fluidically coupling the sample accommodation volume 106 with the flow path 108. The fluid drive units 102, 104 of the fluid drive arrangement 20 are two functionally cooperating fluid pumps driving the mobile phase before injecting the fluidic sample from the sample accommodation volume 106 in the flow path 108.

A respective one of the fluid drive units 102, 104 being presently pressure-decoupled from the flow path 108, may be configured, additionally to intaking the sample from the sample vial, also to bring the sample accommodation volume 106 from ambient pressure up to system pressure in the flow path 108 (for instance 1200 bar) before switching or otherwise connecting the sample accommodation volume 106 into or to the flow path 108. The control unit 70 can control the fluidically coupling of the sample accommodation volume 106 with the flow path 108 after the pressurizing by correspondingly switching fluidic valve 112. Moreover, the control unit 70 is adapted for operating the respective remaining (i.e. the not pressure-decoupled or pressure separated) fluid drive unit 102, 104 for continuously supplying mobile phase to the sample separation unit 30 while the presently decoupled fluid drive unit 102, 104 is decoupled from the flow path 108. Furthermore, the fluidic paths of the instrument are switchable by the control unit 70 by a (not shown) fluidic valve or another switching appliance to selectively switch a respective one of the fluid drive units 102, 104 to be fluidically coupled or pressure coupled with the flow path 108 or to be pressure-decoupled from the flow path 108.

FIG. 1 also shows schematically how the sample accommodation volume 106 can be filled with a fluidic sample. For instance, a needle 91 may be temporarily driven out of a needle seat (not shown) of the injector 40 and may be temporarily immersed (see reference numeral 95) into a fluidic sample liquid 92 in a vial or other fluid container 93. An aliquot of the fluidic sample liquid 92 may then be drawn into the sample accommodation volume 106 via the needle 91. The fluidic sample in the sample accommodation volume 106 is then at or close to ambient pressure.

FIG. 2 shows a sample separation device 10 (e.g. as described for FIG. 1) in a coupled operation mode (main pass), in accordance with embodiments of the present disclosure. In the coupled operation mode, the valve 112 is switched so that the first fluid drive unit 102 and the second fluid drive unit 104 are coupled in series, whereby the first fluid drive unit 102 is arranged in process direction upstream of the second fluid drive unit 104. Thus, the first fluid drive unit 102 is fluidically connected to a mobile phase storage 25 and pumps/draws the mobile phase (one or more solvents) in process direction towards the second fluid drive unit 104.

The second fluid drive unit 104 the pumps the mobile phase in process direction of the flow path 108 via the sample accommodation volume 106 towards the separation unit 30. Thus, in the coupled operation mode, the mobile phase is streamed in process direction downstream of the fluid drive arrangement 20 through the sample accommodation unit 106, thereby taking up the fluidic sample accommodated in the sample accommodation unit 106 and transporting the mobile phase together with the fluidic sample into the sample separation unit 30. In the coupled operation mode, the first fluid drive unit 102 and the second fluid drive unit 104 are pressure-coupled with each other, both in a high-pressure path. In this coupled operation mode, a damper device 160 is not switched into the flow path 108.

FIG. 3 shows a sample separation device 10 in a first transition state, in accordance with embodiments of the present disclosure. The first transition state (conditioning) is temporarily present when switching between the coupled operation mode and the decoupled operation mode. It can be seen that the sample accommodation volume 106 is switched out of the flow path 108 from fluid drive arrangement 20 to sample separation unit 30. Thus, the fluid drive arrangement 20 is now directly connected via the flow path 108 to the sample separation unit 30 (mobile phase without fluidic sample).

In this (optional) conditioning configuration, the sample is “parked” in the sample accommodation volume 106 (needle), while primary and secondary pistons 102, 104 are flushing the flow path 108 and column 30 to compensate for potential artifacts which could have been created by operating the pump 20 in a single piston 102 configuration.

In a specific embodiment (comprising a different switching valve design, not shown), a damper device 160 can be pre-loaded to a system pressure or even above, e.g. by being briefly fluidically isolated together with one of the pump drives 102, 104, which pump drive would then charge the damper device 160 to a high pressure when suitable, whereas in the next transient switching position the sample loop might be connected to the damper device 160 and thus pressure-equilibrated to a pressure close to the system pressure, whereas the fluidic drives 102, 104 might be providing the flow into the system. This might be a position similar to the FIG. 3 transition state position. After the pressure equilibration of the sample in this way, the sample loop 106 can be switched into the main pass.

FIG. 4 shows a sample separation device 10 in a decoupled operation mode (bypass), in accordance with embodiments of the present disclosure. From the above described first transition state, the switching valve 112 now switches to the decoupled operation mode. Hereby, the first fluid drive unit 102 and the second fluid drive unit 104 (fluidically coupled in series in the coupled operation mode) are now decoupled from each other (no fluidic flow between these entities). Instead, the first fluid drive unit 102 is now coupled to the sample separation unit 30 without the second fluid drive unit 104 and/or the sample accommodation volume 106 in between in the flow path 108. The first fluid drive unit 102 can now draw/pump mobile phase from mobile phase container 25 towards the sample separation unit 104, but no sample can be injected in this configuration.

The damper device 160 is hereby switched in the flow path 108 between the first fluid drive unit 102 and the sample separation unit 30 in order to damp flow pulsation (see also FIG. 10). The damper device 160 can be highly efficient in order to compensate for the decoupled second fluid drive unit 104.

The decoupled second fluid drive unit 104 is now fluidically coupled to the sample accommodation volume 106 in a low pressure decoupled flow path 109. Since both the second fluid drive unit 104 and the sample accommodation volume 106 are decoupled from the flow path 108, a sample intake (e.g. from a sample vial) can take place. The second fluid drive unit 104 operates hereby as a metering device that draws a specific amount of sample into the sample accommodation volume 106. Most interestingly, no additional metering device (as in conventional systems) is required for metering/intaking sample to the sample accommodation volume 106.

In the decoupled operation mode, the first fluid drive unit 102 and the second fluid drive unit 104 are pressure-decoupled from each other. In a specific embodiment, the sample flow path 109, that leads from the second fluid drive unit 104 through the sample accommodation unit 106, can be blocked (105) in process direction downstream of the sample accommodation unit 106. When the sample flow path 109 is blocked and the second fluid drive unit 104 provides pressure (by pumping) on the sample accommodation volume 106, the fluidic sample can be (pre-)compressed. A pre-compressed sample can be injected into a high-pressure path more efficiently.

More specifically, once the sample has been pre-compressed, the valve 112 may switch to the transition state according to the FIG. 3. Apparently the flow path 109 is never opened during this switching, and thus the high pressure remains preserved in the path 109, i.e. the pre-compressed sample state is maintained. Also, after (optional) conditioning time interval, in course of switching the valve 112 back to the coupled state, the pre-compressed sample in the accommodation unit 106 in the flow path 109 is never decompressed but is rather connected to the high-pressure path or its components stay under high (system) pressure.

In other words, in one variant of the system, the metering device is made obsolete, and the secondary piston 104 of the pump 20 is used to meter the fluidic sample, while the primary piston 102 continues to provide a flow in the analytical path 108 of the system (in bypass configuration). The pump 20 is then effectively running as a single piston pump 102. To enhance lifetime of fluidic components of the flow path including the column 30, a passive damper 160 can be used to reduce pressure spikes. In the bypass configuration, the secondary piston 104 is used as a metering unit to meter the sample and to operate the injection sub-path, e.g. to pre-compress the sample etc.

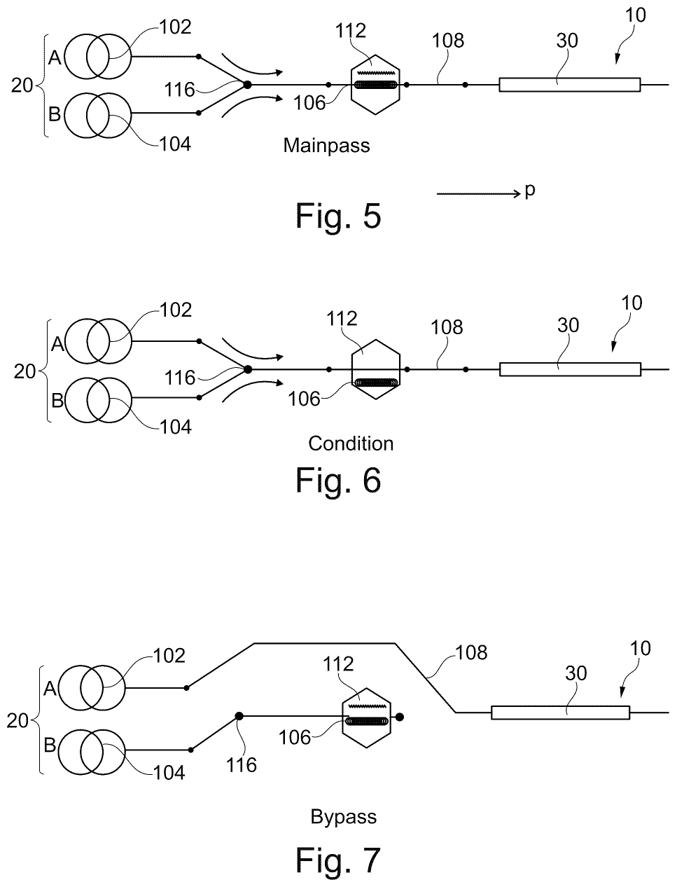

FIG. 5 shows a sample separation device 30 fluid path in a coupled operation mode (main pass), in accordance with embodiments of the present disclosure. This operation mode is very similar to the one described for FIG. 2, yet illustrated in another manner. The first fluid drive unit 102 pumps a first solvent A into the flow path 108, while the second fluid drive unit 104 pumps a second solvent B into the flow path 108. At a mixing point 116, both solvents A, B are mixed to stream as the mobile phase along the flow path 108 towards the sample separation unit 30. In this example, the switching unit 112 couples the sample accommodation volume 106 into the flow path 108, so that the accommodated sample is injected into the mobile phase.

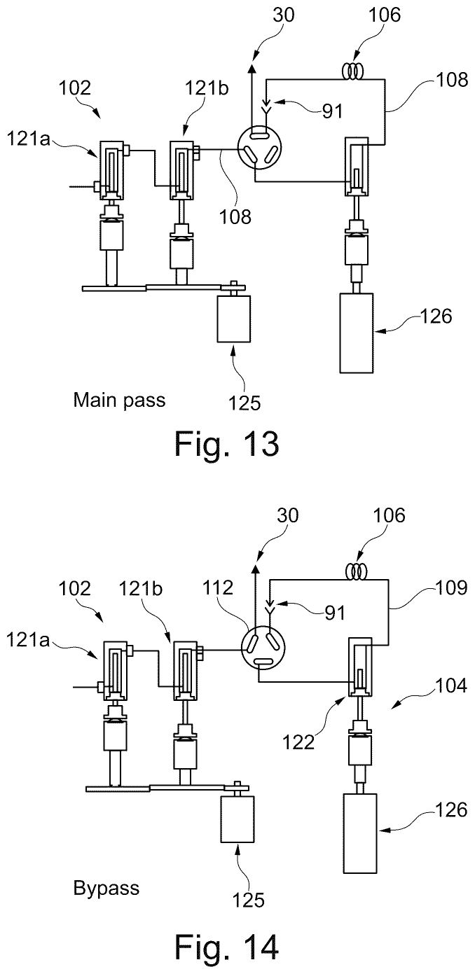

The presently disclosed subject matter is applicable to binary pumps (pumps comprising at least two pump channels, pumping individual fluids separately, whereas the desired fluid composition may be generated in a mixing unit downstream of the pump drives and thus in the high pressure flow path). Either of the channels of a binary pump or a drive comprised in either of the pump channels can be used as the first drive unit 102 and/or the second drive unit 104. One of the channels of the binary pump may stay unchanged and another channel of the binary pump may be adjusted (compare FIGS. 13 and 14).

FIG. 6 shows a sample separation device 10 fluid path in a first transition state, in accordance with embodiments of the present disclosure. In this conditioning state (compare FIG. 3), the sample accommodation volume 106 is decoupled from the flow path 108.

FIG. 7 shows a sample separation device 10 fluid path in a decoupled operation mode (bypass), in accordance with embodiments of the present disclosure. This operation mode is very similar to the one described for FIG. 4, yet illustrated in another manner. The first fluid drive unit 102 is fluidically coupled through the (high-pressure) flow path 108 to the sample separation unit 30. The second fluid drive unit 104 is still coupled to the mixing point 116 and the sample accommodation volume 106, but is decoupled from the first fluid drive unit 102 and the flow path 108. Thus, the path 109 from the second fluid drive unit 104 to the sample accommodation volume 106 is under normal pressure, and the second fluid drive unit 104 can control an intake of sample into the sample accommodation volume 106.

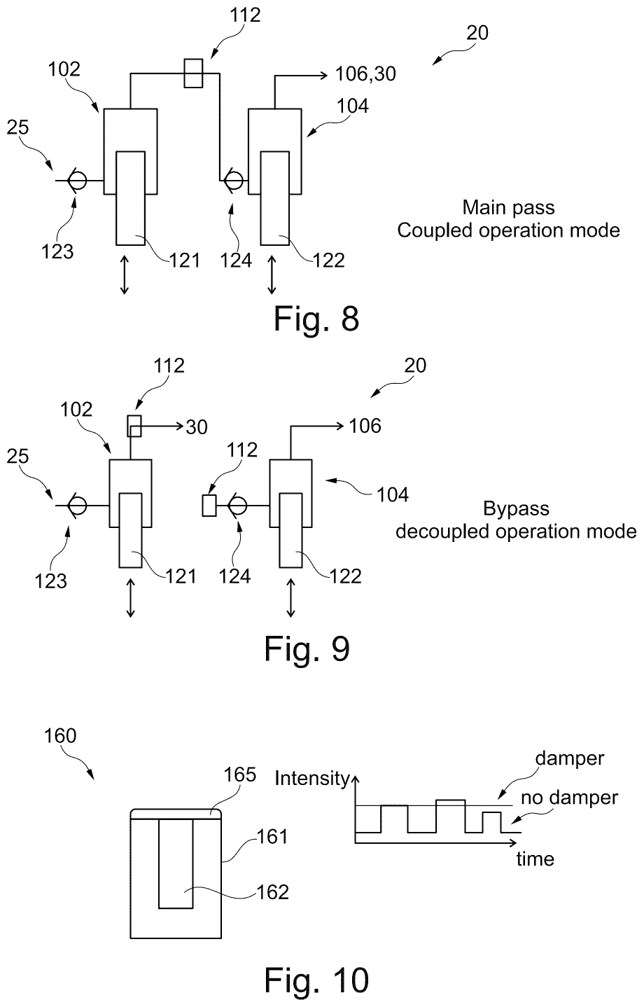

FIG. 8 shows a detailed view of the fluid drive arrangement 20 in a coupled operation mode, in accordance with embodiments of the present disclosure. The fluid drive arrangement 20 comprises the first fluid drive unit 102 with a first piston 121 and the second fluid drive unit 104 with a second piston 122. While the first fluid drive unit 102 is connected to the mobile phase/solvent container 25, the second fluid drive unit 104 is coupled/coupleable to the sample accommodation volume 106 and/or the sample separation unit 30. Process direction upstream of the first fluid drive unit 102, there is arranged a first check valve 123 and process direction upstream of the second fluid drive unit 104, there is arranged a second check valve 124. In this coupled operation mode, the first fluid drive unit 102 and the second fluid drive unit 104 are connected (fluidically) in series by the switching valve 112.

FIG. 9 shows a detailed view of the fluid drive arrangement 20 in a decoupled operation mode, in accordance with embodiments of the present disclosure. In this bypass mode, the switching unit 112 decouples the first fluid drive unit 102 from the second fluid drive unit 104. The first fluid drive unit 102 is now coupled, through the switching valve 112, to the sample separation unit 30, while the second fluid drive unit 104 is now coupled, through the switching valve 112, to the sample accommodation volume 106.

FIG. 10 shows a damper device 160, in accordance with embodiments of the present disclosure. The damper device 160 can be a passive damper device, in particular for damping flow pulsation in the flow path 108, when the second fluid drive unit 104 is decoupled. The damper device 160 can assist a fluidic sample intake operation and/or a fluidic sample compression operation. For example, the control unit 70 is configured to couple the damper device 160 in the decoupled operation mode in the flow path 108 between the first fluidic drive unit 102 and the sample separation device 30.

The exemplary damper device 160 shown comprises an elastic element 165 such as a membrane on top of a damper device volume 161. It is schematically shown that the volume 161 is surrounded by very thick sidewalls in order to be robust against the high pressure in an HPLC. The volume 161 is configured to accommodate a liquid 162 below the elastic element 165.

It is graphically shown that the damper device 160 can dampen flow pulsation (pressure spikes) efficiently in comparison to a system without the damper device 160.

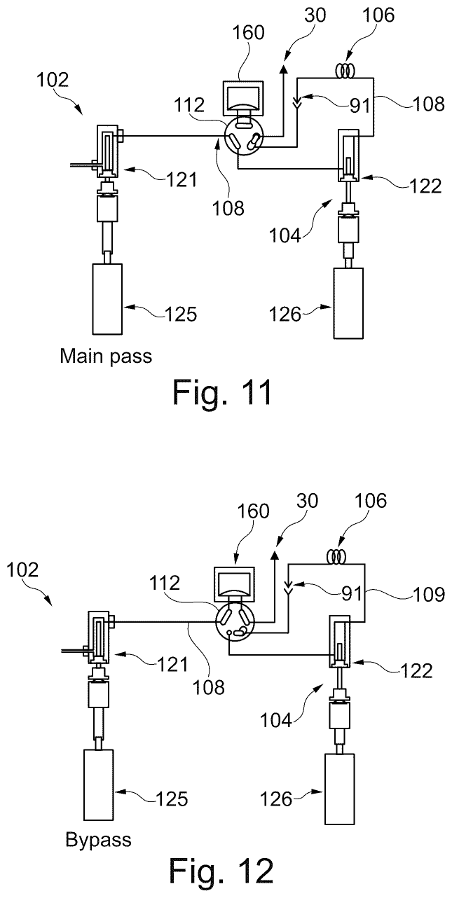

FIG. 11 shows a sample separation device fluid path in a coupled operation mode, wherein each fluid drive unit 102, 104 comprises one pump unit 121, 122, in accordance with embodiments of the present disclosure. The example of FIG. 11 is comparable to the one described for FIG. 2. Here, the fluid drive arrangement 20 comprises the first fluid drive unit 102 and the second fluid drive unit 104. It can be seen that the first fluid drive unit 102 is a single piston pump that comprises one pump unit 121, i.e. one piston in a piston cylinder. In order to drive the first pump unit 121, the first fluid drive unit 102 comprises a first motion source 125, here a motor. In the same manner, the second fluid drive unit 104 is also a single pump that comprises one pump unit 122, i.e. one piston in a piston cylinder. In order to drive the second pump unit 122, the second fluid drive unit 104 comprises a second motion source 126, here another motor. It follows that the first pump unit 125 and the second pump unit 126 are mechanically decoupled and can hence be moved independently from each other.

FIG. 12 shows a sample separation device fluid path in a decoupled operation mode, wherein each fluid drive unit 102, 104 comprises one pump unit 121, 122, in accordance with embodiments of the present disclosure. The example of FIG. 12 is comparable to the one described for FIG. 4. The fluid drive units 102, 104 are configured as described for FIG. 11 above.

FIG. 13 shows a sample separation device fluid path in a coupled operation mode, wherein the first fluid drive unit 102 comprises two coupled pump units 121a, 121b, in accordance with embodiments of the present disclosure. FIG. 13 refers to a main pass configuration as described for FIGS. 2 and 11. The difference to FIG. 11 is in particular that the first fluid drive unit 102 comprises two pump units 121a, 121b (dual piston pump) instead of only one pump unit (single piston pump). It can be seen that each pump unit 121a, 121b comprises a piston/cylinder pair and that both pump units 121a, 121b are coupled with each other in series. Hereby, the first fluid drive unit 102 comprises only one motion source 125 (here a motor) that drives both pump units 121a, 121b. It follows that the pump units 121a, 121b are mechanically coupled and cannot be moved independently from each other. The second fluid drive unit 104, in comparison, comprises only one pump unit 122 with its own motion source 126.

It should further be noted that, in comparison to the examples of FIGS. 11 and 12, no damper device 160 is applied. The use of the dual piston pump may render the flow stable and hence make the damper device 160 redundant.

FIG. 14 shows a sample separation device fluid path in a decoupled operation mode, wherein one fluid drive unit 102 comprises two pump units 121a, 121b, in accordance with embodiments of the present disclosure. The example of FIG. 14 is comparable to the one described for FIGS. 4 and 12. Yet, the fluid drive units 102, 104 are configured as described for FIG. 13 above.

It should be noted here that FIGS. 11 to 14 represent simple implementations of the presently disclosed subject matter with basic functionality, whereas the FIGS. 2 to 4 show a possible enhanced implementation comprising advanced functional features, such as sample pre-compression, decoupling of the sample loop containing compressed sample, column pre-conditioning before injection. Altogether, the FIGS. 2-4 and 11-14 represent only exemplary implementation variants of the disclosure, whereas other switching valve configurations and geometries and different pump topologies along with described in more detail above “binary”, “quaternary”, serial drive, parallel drive topology are possible.

It will be understood that one or more of the processes, sub-processes, and process steps described herein may be performed by hardware, firmware, software, or a combination of two or more of the foregoing, on one or more electronic or digitally-controlled devices. The software may reside in a software memory (not shown) in a suitable electronic processing component or system such as, for example, the control unit 70 schematically depicted in FIG. 1. The software memory may include an ordered listing of executable instructions for implementing logical functions (that is, “logic” that may be implemented in digital form such as digital circuitry or source code, or in analog form such as an analog source such as an analog electrical, sound, or video signal). The instructions may be executed within a processing module, which includes, for example, one or more microprocessors, general purpose processors, combinations of processors, digital signal processors (DSPs), application specific integrated circuits (ASICs), or field-programmable gate arrays (FPGAs). Further, the schematic diagrams describe a logical division of functions having physical (hardware and/or software) implementations that are not limited by architecture or the physical layout of the functions. The examples of systems described herein may be implemented in a variety of configurations and operate as hardware/software components in a single hardware/software unit, or in separate hardware/software units.

The executable instructions may be implemented as a computer program product having instructions stored therein which, when executed by a processing module of an electronic system (e.g., the control unit 70 schematically depicted in FIG. 1), direct the electronic system to carry out the instructions. The computer program product may be selectively embodied in any non-transitory computer-readable storage medium for use by or in connection with an instruction execution system, apparatus, or device, such as an electronic computer-based system, processor-containing system, or other system that may selectively fetch the instructions from the instruction execution system, apparatus, or device and execute the instructions. In the context of this disclosure, a computer-readable storage medium is any non-transitory means that may store the program for use by or in connection with the instruction execution system, apparatus, or device. The non-transitory computer-readable storage medium may selectively be, for example, an electronic, magnetic, optical, electromagnetic, infrared, or semiconductor system, apparatus, or device. A non-exhaustive list of more specific examples of non-transitory computer readable media include: an electrical connection having one or more wires (electronic); a portable computer diskette (magnetic); a random access memory (electronic); a read-only memory (electronic); an erasable programmable read only memory such as, for example, flash memory (electronic); a compact disc memory such as, for example, CD-ROM, CD-R, CD-RW (optical); and digital versatile disc memory, i.e., DVD (optical). Note that the non-transitory computer-readable storage medium may even be paper or another suitable medium upon which the program is printed, as the program may be electronically captured via, for instance, optical scanning of the paper or other medium, then compiled, interpreted, or otherwise processed in a suitable manner if necessary, and then stored in a computer memory or machine memory.

It should be noted that the term “comprising” does not exclude other elements or features and the term “a” or “an” does not exclude a plurality. Also elements described in association with different embodiments may be combined. It should also be noted that reference signs in the claims shall not be construed as limiting the scope of the claims.

### REFERENCE SIGNS

10 Separation Apparatus
20 Fluid drive arrangement
25 Solvent supply
27 Degasser
30 Sample separation device, unit
40 Sample injector
50 Detector
60 Fractionating unit
70 Data processing device, control unit
91 Needle
92 Sample
93 Sample container
95 Sample intake
102 First fluid drive unit
104 Second fluid drive unit
106 Sample accommodation volume, loop
108 Flow path
109 Sample flow path, decoupled
112 Switching unit, fluid valve
116 Mixing point
121 First piston, first pump unit
121a First pump unit
121b Second pump unit
122 Second piston, second pump unit
123 First check-valve
124 Second check valve
125 First motor, common motor
126 Second motor
160 Damper device
161 Damper volume
162 Fluid filling
165 Elastic element, membrane
P Process direction

1. A sample separation apparatus for separating a fluidic sample, the sample separation apparatus comprising:
a fluid drive arrangement comprising a first fluid drive unit and a second fluid drive unit configured to drive a mobile phase along a flow path to a sample separation unit;
a sample accommodation volume configured to accommodate the fluidic sample; and
a control unit configured to control respective operations of the fluid drive units, and to control a fluidically decoupling of the second fluid drive unit from the flow path in a decoupled operation mode of the sample separation apparatus,
wherein the control unit is further configured to control, in the decoupled operation mode, the decoupled second fluid drive unit for:
fluidically coupling to the sample accommodation volume; and
intaking sample into the sample accommodation volume.

2. The sample separation apparatus of claim 1, comprising at least one of:
wherein, in the decoupled operation mode, the first fluid drive unit is coupled to the separation unit;
wherein, in the decoupled operation mode, the second fluid drive unit is decoupled from the separation unit.

3. The sample separation apparatus of claim 1, wherein, in the decoupled operation mode, the second drive unit is operated as a metering device configured to take-up the fluidic sample from a sample container.

4. The sample separation apparatus of claim 1, wherein the control unit is further configured to, in the decoupled operation mode, at least partially block a sample flow path, which leads from the second fluid drive unit through the sample accommodation unit in a process direction downstream of the sample accommodation unit, to thereby compress the fluidic sample.

5. The sample separation apparatus of claim 1, wherein the control unit is further configured to control a coupling between the first fluid drive unit and the second fluid drive unit, in a coupled operation mode, and the first fluid drive unit and the second fluid drive unit are fluidically coupled with each other.

6. The sample separation apparatus of claim 5, comprising at least one of:
wherein, in the coupled operation mode, the first fluid drive unit and the second fluid drive unit are pressure-coupled with each other;
wherein, in the decoupled operation mode, the first fluid drive unit and the second fluid drive unit are pressure-decoupled from each other;
wherein the first fluid drive unit is coupled in a high-pressure path;
wherein the second fluid drive unit is coupled in a normal-pressure path.

7. The sample separation apparatus of claim 5, wherein, in the coupled operation mode, a mobile phase is drawn by the first fluid drive unit from a solvent container, and then streamed to the second fluid drive unit.

8. The sample separation apparatus of claim 5, wherein, in the coupled operation mode, the mobile phase is streamed, in a process direction downstream of the fluid drive arrangement, through the sample accommodation unit, thereby taking up the fluidic sample accommodated in the sample accommodation unit.

9. The sample separation apparatus of claim 1, comprising at least one of:
wherein the sample accommodation unit is configured as one of: a sample loop; a multi-sample storage; a sampler; an autosampler; an injection needle;
wherein the sample accommodation volume is configured to be selectively fluidically coupleable with the flow path or fluidically decoupleable from the flow path.

10. The sample separation apparatus of claim 1, comprising at least one of:
wherein the first fluid drive unit and/or the second drive unit comprises two or more pump units connected to a common motion source;
wherein the first fluid drive unit is arranged in a process direction upstream of the second fluid drive unit;
wherein the first fluid drive unit and the second fluid drive unit are fluidically coupled with each other in series;
wherein the first fluid drive unit and the second fluid drive unit are fluidically coupled with each other in parallel.

11. The sample separation apparatus of claim 1, further comprising a switching unit arranged in a process direction between the first fluid drive unit and the second fluid drive unit, and coupled to the control unit, wherein the control unit is configured to switch between a coupled operation mode and the decoupled operation mode by the switching unit.

12. The sample separation apparatus of claim 1, wherein the sample separation device is free of a metering device.

13. The sample separation apparatus of claim 1, further comprising a damper device configured to damp flow pulsation in the flow path.

14. The sample separation apparatus of claim 13, wherein the control unit is configured to trigger a damping operation of the damper device in order to assist a fluidic sample intake operation and/or a fluidic sample compression operation.

15. The sample separation apparatus of claim 13, wherein the control unit is configured to couple the damper device, in the decoupled operation mode, in the flow path between the first fluidic drive unit and the sample separation device.

16. The sample separation apparatus of claim 13, comprising at least one of:
wherein the damper device comprises an elastic element;
wherein the damper device comprises a damper device volume configured to accommodate a liquid;
wherein the damper device comprises an elastic element and a damper device volume configured to accommodate a liquid, and the damper device is disposed below the elastic element.

17. The sample separation apparatus of claim 1, wherein the control unit is further configured to control:
pressurizing the sample accommodation volume before fluidically coupling the sample accommodation volume with the flow path, wherein the pressurizing is done while the first fluid drive unit is operating; and
de-pressurizing the sample accommodation volume after fluidically coupling the sample accommodation volume with the flow path for preparing a subsequent intake of fluidic sample in the sample accommodation volume, wherein the de-pressurizing is done while the first fluid drive unit is operating.

18. The sample separation device of claim 1, wherein the sample separation device is configured as a fluidic chromatography device.

19. A method of operating a sample separation apparatus, the method comprising:
driving a mobile phase along a flow path to a sample separation unit by a fluid drive arrangement, which comprises a first fluid drive unit and a second fluid drive unit;
accommodating a fluidic sample in a sample accommodation volume;
fluidically decoupling the second fluid drive unit from the flow path in a decoupled operation mode of the sample separation apparatus;
fluidically coupling, in the decoupled operation mode, the decoupled second fluid drive unit to the sample accommodation volume; and
intaking sample into the sample accommodation volume.
